(19) United States
(12) Patent Application Publication
(10) Pub. No.: US 2016/0072777 A1
(43) Pub. Date: Mar. 10, 2016

(54) HARDWARE CRYPTO MODULE AND SYSTEM FOR COMMUNICATING WITH AN EXTERNAL ENVIRONMENT

(71) Applicant: Fraunhofer-Gesellschaft zur Foerderung der angewandten Forschung e.V., Munich (DE)

(72) Inventors: Andreas JAKOBY, Luebeck (DE); Dimitri HELWIG, Karlsruhe (DE)

(21) Appl. No.: 14/542,036

(22) Filed: Nov. 14, 2014

(30) Foreign Application Priority Data
Nov. 15, 2013 (DE) 10 2013 223 366.3

(51) Int. Cl. H04L 29/06; G06F 21/72

(52) U.S. Cl. CPC H04L 63/0471; H04L 63/06; G06F 21/72

(57) ABSTRACT

A hardware crypto module encrypts or decrypts data from a device, the device being arranged to be remote and separate from the crypto module in terms of hardware. The crypto module includes an interface for communicating with the remotely arranged device, a memory, and a crypto processor. The crypto processor is configured to encrypt or decrypt, while using a first key, data received via the interface, to encrypt the first key while using a second key stored in the memory, and to output the first key via the interface exclusively in an encrypted form.

### CROSS-REFERENCE TO RELATED APPLICATIONS

This application claims priority from German Patent Application No. 10 2013 223 366.3, which was filed on Nov. 15, 2013, and is incorporated herein in its entirety by reference.

The present invention relates to the field of data communication, in particular to transmission of encrypted data between a device such as a computer, for example, and an external environment such as a network, for example. In particular, according to embodiments, the present invention relates to a hardware crypto module for encrypting or decrypting data, to a system for communicating with an external environment, which system comprises such a hardware crypto module, as well as to the key management system used therein.

### BACKGROUND OF THE INVENTION

Utilization of mobile terminal devices plays an increasingly important role; in particular high-power terminal devices, which enable immediate access to the internet or to the intranet of an organization, are of central importance. In addition to notebooks and netbooks, this group of devices also includes tablet computers and smartphones. Security of said devices is an important aspect in communicating with the environment, various cryptography methods being generally resorted to for ensuring the security of data. The above-mentioned terminal devices serve both to input and to output data, for example via a user interface, a so-called man-machine interface. Since the data are displayed to a user, it is not possible to provide the data on the terminal device in a permanently encrypted manner, so that as a consequence, theft of individual data sets cannot be prevented entirely. However, what is more problematic than the loss of individual data sets is the loss of control over access to large amounts of sensitive data, which may occur possible, for example, when the keys used for encryption get into the wrong hands.

Various approaches addressing the above-described problem have been known in conventional technology and are based on protecting data by means of a software encryption method or a hardware encryption method. However, said approaches known in conventional technology are specified in different manners as a function of the type of device, of the type of communication and/or of the device's operating system, so that certain approaches may be employed only for smartphones, but not for tablet PCs, or only for notebooks, but not for smartphones. Likewise, different approaches are provided for protecting telephone conversations, SMS services or e-mails. Different solutions are proposed for different device operating systems, for example the Android operating system or the iOS.

Known approaches for secure encryption of a mobile communication are based on a pure software method, on a pure hardware method, or on a hybrid method.

In a software method, the data, e.g. the content of a conversation, is encrypted by means of a specific software. Since an attacker in this case only needs to manipulate the software or the operating system of the terminal device, said methods offer only a limited form of security. In fact, terminal devices that have been manipulated accordingly may be used for obtaining information about the keys used for encryption, which are subsequently used for decrypting or manipulating any encrypted contents and/or encrypted data. In some known software methods, virtualization is employed, which serves to reduce the above-mentioned deficiencies, for example in connection with hacker attacks, viruses and the like, by retaining the data within a predefined context. In particular, this is to prevent undesired data leakage. By means of virtualization, different devices may be rendered free from information and thus be rendered unserviceable for the information flow of business data. In order to allow both personal and business uses on a terminal device, two virtual machines are implemented. One of said machines, namely the one for business use, is heavily regulated and is provided for using business data and application programs or apps, whereas the other virtual machine comprises fewer restrictions and is reserved for personal affairs. Known approaches provide a hypervisor arranged as an intermediate layer between the hardware and the two virtual systems.

In order to increase security, other software solutions known in conventional technology use so-called container solutions (sandbox) which operate such that individual applications run only in a dedicated, predetermined environment (container, sandbox). However, this allows limited access only. The individual applications are cut off from one another within the container, or within the sandbox, which is disadvantageous to the effect that a comprehensive view and, thus, a common interface with the user is not provided, so that, for example in the case of a business address book and a personal address book, said address books are separate from each other, and a joint function for searching one address book across both address books is not provided and, also, is not possible.

A further approach, known in the art, to secure data transmission uses a hybrid method consisting, for example, of a smartcard and an application software which may be used for encrypting and decrypting, e.g., voice data and SMS messages. The microprocessor present on the smartcard initiates a secure connection setup and performs encryption. Once the smartcard has been inserted into the card slot of a mobile telephone and once a pin has been entered, a public key infrastructure environment performs authentication and key delivery, e.g. by using a PKI server. What is disadvantageous about this hybrid concept is that the smartcard used typically supports only specific operating systems, so that other well-known operating systems cannot work with this system. Moreover, utilization of the smartcard represents a hardware extension of the original device, which with some devices is possible, but the processing and signal delay times that may be used which allow sufficiently fast encryption of the data, for example encryption of voice data in real time, is not always made possible. If this concept is implemented in pure software without that of the smartcard, this will result, for reasons endemic to the system, to a clearly reduced security level as compared to the combination of software and hardware. A further disadvantage of this approach consists in that one of the card slots of the terminal device is occupied and can thus no longer be used for memory extensions. Moreover, such hybrid approaches typically support only a limited selection of platforms and thus enable only a limited circle of users to employ it.

In addition, conventional technology knows pure hardware approaches wherein the terminal device, e.g. the smartphone, is “hardened”. Alternative approaches employ additional hardware for encryption.

The disadvantage of hardened mobile devices consists in that they are offered only by specific providers which use specific operating systems that have been hardened and which implement communication via a proprietary protocol and via manufacturer-specific nodal points. Thus, this involves investment in specific terminal devices so as to provide a possibility of consistent end-to-end encryption altogether.

Another approach is the additional use of hardware, for example in the form of a crypto chip within the terminal device, said crypto chip storing the keys such that also a new owner of a device has no further access to same. The crypto chip performs encryption and decryption operations of data and telephone conversations, and together with a selected software it offers, during protected startup of the device, sufficient security so as to be enabled for communicating state secrets. A further known approach consists in rolling out an encryption module to a separate hardware which will then be connected to the actual terminal device via an interface, for example via a Bluetooth interface or a USB interface, so as to exchange the data. For data encryption, a key is generated with the remote terminal device via a key agreement protocol, said key being subsequently used for encrypting the communication. The disadvantage of the above-mentioned known hardware-based approaches is that they can be applied only for a limited number of terminal devices and that their possibilities of being adapted to future developments in cryptography are limited.

### SUMMARY

According to an embodiment, a hardware crypto module for encrypting or decrypting data from a device that is arranged to be remote and separate from the crypto module in terms of hardware may have: an interface for communicating with the remotely arranged device, a memory, a crypto processor configured to encrypt or decrypt, while using the first key, data received via the interface, to encrypt the first key while using a second key stored in the memory, and to output the first key via the interface exclusively in an encrypted form.

According to another embodiment, a system for communicating with an external environment may have: a device including an interface with the external environment, and a hardware crypto module as claimed in claim 1, which is separate from the device in terms of hardware and is configured to communicate with the device via its interface.

The inventive approach is based on a modular architecture with exchangeable modules—an approach that is not provided in conventional known approaches that were discussed above. According to the invention, the above-mentioned, highly problematic loss of keys is avoided in that the keys (the first key and/or the second key) are protected by further encryption, and in that the unencrypted keys are present only in the specific crypto module that is separated in terms of hardware, said module further performing encryption and decryption of data as well as encryption and decryption of keys. The inventive crypto module is also referred to as a cypher gateway.

According to embodiments, a communication module may further be provided which enables operating the crypto module in most varied terminal devices, so that the inventive approach is advantageous in that the above-described limitations of using the individual, known encryption approaches no longer exist; rather, a universally applicable approach is disclosed which enables secure encryption and secure administration of the keys in any terminal devices. The integrated key management system that has just been mentioned is advantageous since it allows a user to directly access encrypted data via a terminal device without the necessity of performing a complicated protocol for exchanging keys. Such an approach is not known in conventional technology; rather, known methods involve resorting to methods of public key cryptography, such as the Diffie-Hellman method for key exchange.

What is disadvantageous about approaches as are known in conventional technology is that the key used for encryption may be recalculated again and again between the parties and/or terminal devices involved. By contrast, the inventive approach is advantageous since no new key calculation is necessary upon exchange of the keys.

The present invention is based on the finding that for ensuring the security of the data, first of all the security of the keys is guaranteed, which is effected, according to the invention, by means of the hardware crypto module and/or the cypher gateway. The crypto module ensures that outside of the crypto module realized in hardware the keys are used, stored or sent in an encrypted form only. The keys used outside the crypto module are encrypted with base keys stored within the crypto module, so as to produce the encrypted key. This procedure guarantees that the authorization that access to any data encrypted with said key is allowed can be derived from the knowledge of the base key (of the key used for encrypting the key). For example, if kⱼ represents a group of base keys, only those keys kᵢ which said group may access are allowed to be encrypted with kⱼ. According to embodiments, the above properties may be ensured by means of strict rules and/or by means of a centralized key management system.

According to embodiments, the second key may be the above-mentioned base key; the following shall be noted as regards the term “base key”. Strict separation between base key and non-base key is dependent on the respective application. It may be useful, for example, to forward keys also beyond the reach of a base key, e.g. when data sets are to be forwarded across several areas (which overlap in each case). In such cases, the second key used is not a base key, which is present within the crypto module exclusively, but as the second key, a key is employed which may also be used, stored or sent outside the crypto module in an encrypted manner.

According to embodiments, the inventive approach includes three modules, namely the inventive hardware crypto module as well as, additionally, a communication module and an integration module, which enables taking developments regarding the terminal device, the communication method and/or the encryption method into account without the entire system being affected. Moreover, the inventive approach may be employed in different terminal devices, e.g. a stationary PC, a portable laptop, or a smartphone. Depending on the capacity of the terminal device, the communication module may be implemented on the terminal device in software or as a separate hardware module.

The inventive approach of implementing the crypto module as a separate hardware module results in maximizing security.

The above-mentioned integrated key management system, which may be implemented, for example, both in the crypto module and partly in the communication module, enables optimizing the memory resources without reducing security. For example, when employing a communication module, rolling out encrypted keys to the communication module may be performed so as to enable optimum use of the scarce hardware resources of the actual crypto module.

The inventive approach enables secure encryption of data; data generally relating to digital data, said data also including, in addition to classical text messages and documents, multimedia data such as voice, e.g. in telephony, digital photos, films and the like.

The inventive approach may be used in any areas where data may be sent in an encrypted manner via unreliable channels or may be stored in an encrypted manner in unreliable storage systems. In such systems, protection of the key in many cases is more important than protection of individual documents, and due to its modular architecture, the inventive approach supports the exchange of data between most varied terminal devices without involving profound modification of the actual terminal devices. Thus, data may advantageously be exchanged in an efficient and secure manner, for example between a smartphone and a database server, the protection of the data being guaranteed by the protection of the key used; said key remains protected, due to its encryption, also in those cases in which the actual terminal device is compromised.

### BRIEF DESCRIPTION OF THE DRAWINGS

Embodiments of the present invention will be detailed subsequently referring to the appended drawings, in which:

FIG. 1 shows a schematic representation of the architecture of an inventive system, which is also referred to as a cypher gateway;

FIG. 2 shows a representation of the system of FIG. 1, wherein more details of the individual modules are schematically depicted;

FIG. 3 shows a diagram of the steps that are to be performed in the integration module in case of data encryption and which are performed, e.g., by the signal processor of the integration module;

FIG. 4 shows the steps performed in the integration module in connection with data decryption for displaying the decrypted data on the user interface of the terminal device;

FIG. 5A-5B shows flowcharts regarding the key request directed to the system, e.g. on the part of a transmitter in the external environment (FIG. 5A), as well as regarding the system's response to the transmitter (see FIG. 5B);

FIG. 6A-6B shows the functionality of the integration module in connection with the key request on the part of the system, directed to a receiver in the external environment (FIG. 6A), as well as in connection with the receivers response to the system (see FIG. 6B);

FIG. 7A-7B shows the functionality of the communication module in the encryption of data, FIG. 7A showing the functionality of the communication module in connection with processing the encryption request, and FIG. 7B showing the functionality of the communication module in connection with processing the encryption response;

FIG. 8A-8B shows the functionality of the communication module in the decryption of data, FIG. 8A showing the functionality of the communication module in connection with processing the decryption request, and FIG. 8B showing the functionality of the communication module in connection with processing the decryption response;

FIG. 9 shows the functionality of the communication module which is active in connection with a key request on the part of the external environment;

FIG. 10 shows an example of the functionality of the communication module in connection with a key request made by the system of FIG. 2 and directed to the external environment;

FIG. 11 shows a flowchart of an intramodule key request, e.g. a request for a specific key made on the part of the crypto module and directed to the communication module;

FIG. 12 shows the functionality of the communication module during forwarding of a response from the external environment to a key request;

FIG. 13 shows the operational sequences within the communication module when the crypto module provides a response to a key request made by the external environment;

FIG. 14 shows the functionality of the communication module for storing an encrypted key in the memory of the communication module;

FIG. 15 shows the functionality of the communication module for storing data in the memory of the communication module;

FIG. 16 shows the functionality of the crypto module in connection with the processing of an encryption request;

FIG. 17 shows the functionality of the crypto module in connection with processing a decryption request;

FIG. 18 shows the operational sequences within the crypto module for internal key determination;

FIG. 19 shows the operational sequences within the crypto module for external key determination;

FIG. 20 shows the functionality of the crypto module in connection with processing a key request and/or with providing an encrypted key to the communication module; and

FIG. 21 shows the functionality of the crypto module in connection with processing a request for a base key and/or with providing an encrypted base key to the communication module.

### DETAILED DESCRIPTION OF THE INVENTION

Embodiments of the inventive hardware crypto module and embodiments of the inventive system using such a hardware crypto module will be described in more detail below. Elements in the figures that are identical or have identical actions are designated with identical reference numerals in the description which follows.

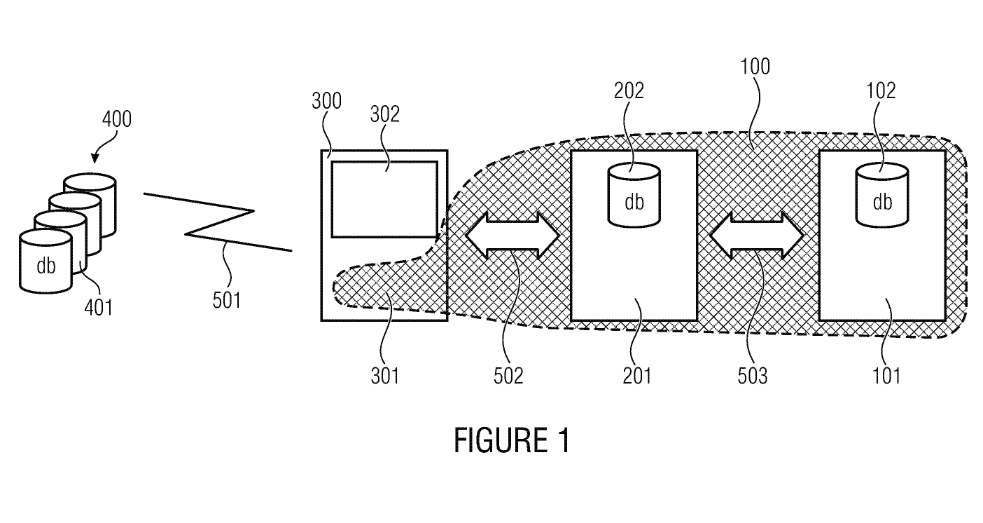

FIG. 1 shows a schematic representation of the architecture of the inventive system, which is also referred to as a cypher gateway. The inventive system 100 is schematically represented by the hashed area and includes the crypto module 101, the communication module 201, and an integration module 301 implemented within a terminal device 300. According to embodiments, the integration module 301 is a component which may be implemented directly on the terminal device; depending on the architecture and performance of the terminal device 300, it is also possible for the communication module 201 to be implemented on the terminal device 300. According to the invention, the crypto module 101 is separate from the terminal device 300 in terms of hardware.

The crypto module 101 includes a memory 102, e.g. in the form of a database or a cache memory, for unencrypted data or keys. The communication module 201 also includes a memory 202, e.g. in the form of a database or a cache memory, for storing encrypted data or encrypted keys within the communication module 201. In addition to the integration module 301, the terminal device 300 also includes a user interface 302, which is also referred to as a man-machine interface.

Moreover, the system may communicate with an external environment 400, for example a public network, the internet, or an intranet; reference numeral 401 generally indicating stored data, external memory locations or external data receivers or transmitters that are accessible via the public network, internet or intranet. In addition, the external environment 400 may include a public or internal memory, a computing center, or a cloud.

Reference numeral 501 schematically represents a communication between the terminal device 300 and the external environment 400. Reference numerals 502 and 503 schematically represent a communication between the terminal device 300 and the communication module 201 and/or between the communication module 201 and the crypto module 101.

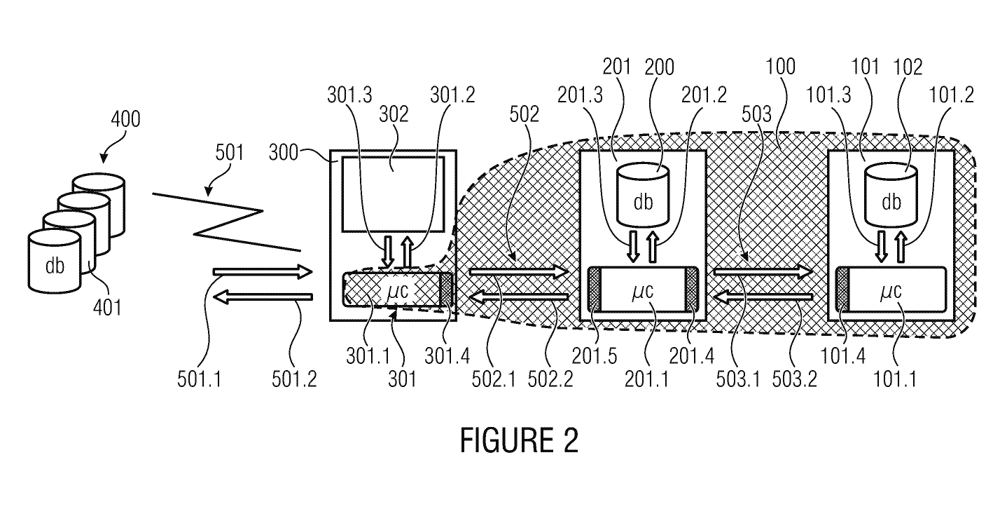

For describing the functional connections between the elements described by means of FIG. 1, FIG. 2 shall subsequently be resorted to, which shows a representation of the system of FIG. 1 wherein further details of the individual modules are schematically depicted. Moreover, further details are shown with regard to the communication between the individual modules. In addition to the memory 102, the crypto module 101 includes an active component 101.1, for example a crypto processor 101.1, and an external interface 101.4 for sending/receiving data. The crypto processor 101.1 is effectively connected to the memory 102 and the interface 101.4, the arrows 101.2 and 101.3 schematically representing the exchange of messages between the crypto processor 101.1 and the memory 102 of the crypto module 101.

In addition to the memory 202, the communication module 201 includes an active component, e.g. a communication module processor 201.1, as well as external interfaces 201.4 and 201.5 for communicating with the crypto module 101 and/or the integration module 301. Reference numerals 201.2 and 201.3 represent internal communication between the memory 202 of the communication module 201 and the communication module processor 201.1.

The integration module 301 includes a signal processor 301.1 as well as an interface 301.4 for communicating with the communication module 201. The arrows 301.2 and 301.3 schematically represent a communication between the user interface 302 of the terminal device 300 and the signal processing device 301.1 of the integration module 301.

In FIG. 2, the arrows 501.1 and 501.2 indicate messages that are sent from the external environment 400, for example the public network, the internet or an intranet, to the terminal device 300, and messages sent from the device 300 to the external environment 400, respectively. Likewise, arrows 502.1 and 502.2 and/or 503.1 and 503.2 indicate the exchange of messages between the integration module 301 and the communication module 201 and between the communication module 201 and the crypto module 101, respectively.

According to the embodiment represented, the crypto module 101 has the central task of decrypting and encrypting data and decrypting and encrypting keys as well as generating new keys and storing or temporarily storing (caching) unencrypted keys. According to the invention provision is made that it is ensured, for example by realization in terms of protocol, that no key leaves the crypto module 101 unencrypted. More precisely, it is ensured that, in addition to the first key, also the base key is provided exclusively in an encrypted form outside the crypto module 101. What is permanently stored on the crypto module 101 are advantageously only those base keys used for the application which can be supplemented in terms of protocol if desired. All the other keys are temporarily stored on the crypto module 101. The crypto module 101 and the communication module 202 communicate, in the example represented, via the interfaces 101.4 and 201.4, which may be configured as USB interfaces, for example.

The communication module 202 serves to set up and perform the data and key transfer between the terminal device 300 and the crypto module 101. According to the embodiment represented, it further serves to store or temporarily store encrypted data and encrypted keys. The communication module may be provided if it is not ensured that the terminal device has the interface that may be used for directly communicating with the crypto module 101. In such an embodiment, the crypto module 201 is provided so as to translate between the respective interfaces and protocols that are used in the terminal device 300 and in the crypto module 101, respectively, the communication module 200 also providing, according to embodiments, the encryption methods used for the protocols involved. In the embodiment shown in FIG. 2, provision may be made that the communication with the terminal device 300 is performed via a Bluetooth connection, for example using an AES encryption, and that communication with the crypto module is effected via a USB interface. According to embodiments, the communication module 201 is further provided to temporarily store encrypted keys and encrypted data since the memory 202 of the communication module 201 may be designed to be larger, by orders of magnitude, than the memory 102 of the crypto module 101, so that regularly used keys may be stored such that they are efficiently accessible to the crypto module while being protected due to the additional encrypted storage.

The integration module 301 serves to involve the crypto module 101 and the communication module 201, if present, in the communication between the user of the terminal device 300 and the external environment 400. Moreover, the integration module serves, according to embodiments, to forward key requests on the part of the crypto module to the external environment 400.

If data is to be sent via a network, for example the external environment 400, the integration module 301 will initially cause said data to be encrypted prior to the actual transmission of the data via the net 400 in that the data is sent to the crypto module 101 via the communication module 201. At the crypto module 101, the data is encrypted and is subsequently conveyed to the device 300 via the communication module 201 and the integration module 301. For receiving and displaying encrypted data on the terminal device 300, this path is reversed, i.e. the encrypted data is forwarded from the device 300 to the crypto module 101 via the integration module 301 and the communication module 201, is decrypted at said crypto module 101 and is then returned to the terminal device 300 for being displayed on the user interface 302.

In situations where the crypto module 101 ascertains that a key may be used that is not present within the crypto module 101, a key request is generated, according to embodiments, by means of the crypto module 101, which key request is forwarded to a receiver, for example a key server in the public network 400, via the communication module 201 and the integration module 301.

In the system described in detail by means of FIG. 2, essentially the following types of communication occur in connection with encryption/decryption:
1. encryption request
2. decryption request
3. encryption response
4. decryption response
5. key request
6. key response
7. Store key
8. data
9. error

In addition, the integration module includes application-dependent key identifications (key IDs) for the keys that are to be used for encrypting individual data and keys. The crypto module 101 includes specific key identifications (key IDs) of the base keys of a user and the associated base keys, which are stored unencrypted in the memory 102 of the crypto module 101. Individual functional sequences will be explained in more detail by means of the following figures. According to one embodiment provision may be made that the terminal device 300 or the integration module 301, which may trigger an encryption or decryption request, identify themselves before the connected crypto module 101, the corresponding steps not being represented in the following figures. According to embodiments, the crypto module 101 may comprise, as a protection from utilization on the part of non-authorized persons, an identification method according to which a user identifies himself/herself before the crypto module 101 by entering a PIN (personal identification number) directly at the module itself. The crypto module 101 will enable its functionality only after the correct PIN has been entered. In addition, provision may be made that the functionality of the crypto module 101 will be permanently blocked after an incorrect PIN has been entered several times.

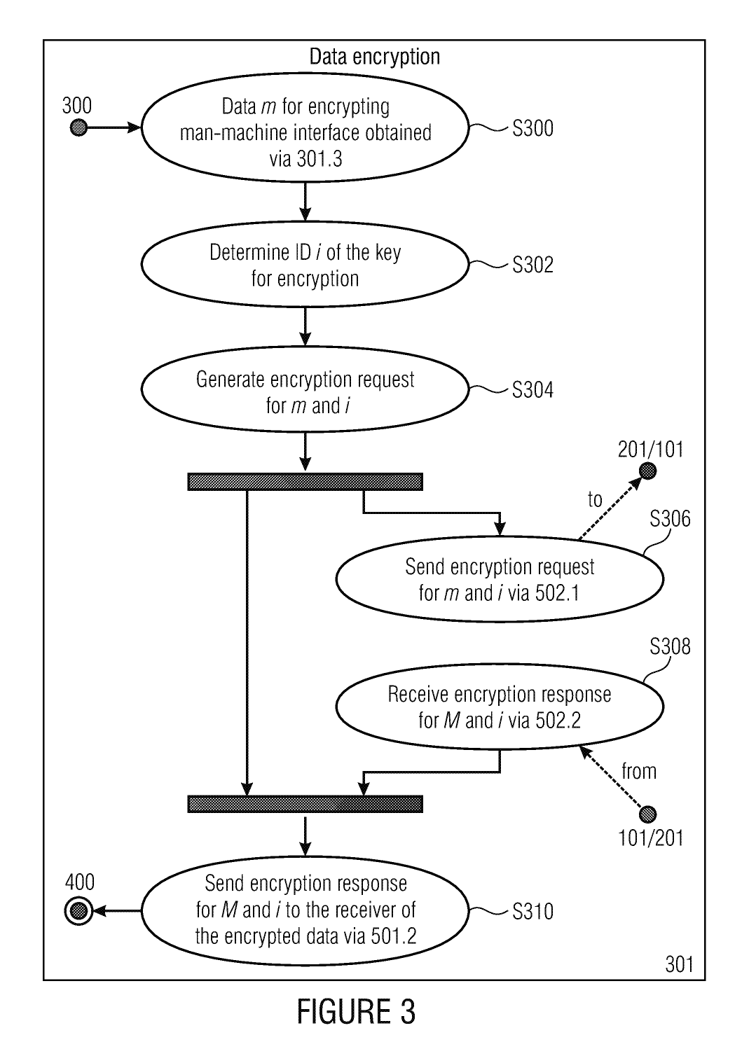

The functionality of the integration module 301 according to the embodiment shown in FIG. 2 will be explained in more detail below with reference to FIGS. 3 to 6. The functionality described by means of the figures is provided, e.g., by the signal processor 301.1 shown in FIG. 2. The following notations shall be used in the diagrams shown in the following figures:
m unencrypted data
M encrypted data
kᵢ key with which the data m is encrypted
I key ID of the key kᵢ
K encrypted key kᵢ
kⱼ base key with which the key kᵢ is encrypted
j base key ID of the key kⱼ
I, J amounts of indices of keys in a key request, a key from the amount of the key IDs “I” being encrypted with one of the keys from the amount of the key IDs “J”,
D any data packet

FIG. 3 shows a diagram of the steps which arise in the integration module 301 in the event of data encryption and which are performed, e.g., by the signal processor 301.1. In a first step S300, the integration module 301 receives the data m envisaged for encryption from the terminal device 300, more specifically via the user interface 302 and the message 301.3. In step S302, the integration module 301 determines the key ID i of the key kᵢ envisaged for encryption. In step S304, the integration module 301 generates an encryption request for the data m while using the key kᵢ with the key ID i. The encryption request generated in step S304 is output via the interface 301.4 in step S306, for example via the message schematically represented at 502.1 in FIG. 2. In step S308, following successful encryption on the part of the system, the integration module 301 receives the encryption response, for example via the message 502.2 schematically represented in FIG. 2. In addition to the data M which are now encrypted, the encryption message also contains the key ID i of the key kᵢ used for encrypting the data m. Following reception of the encryption response, the integration module 301 effects, in step S310, conveyance of the encryption response to the device 300 for transmission to the receiver of the encrypted data, for example to a receiver arranged in the external environment 400, via a message schematically shown at 501.2 in FIG. 2.

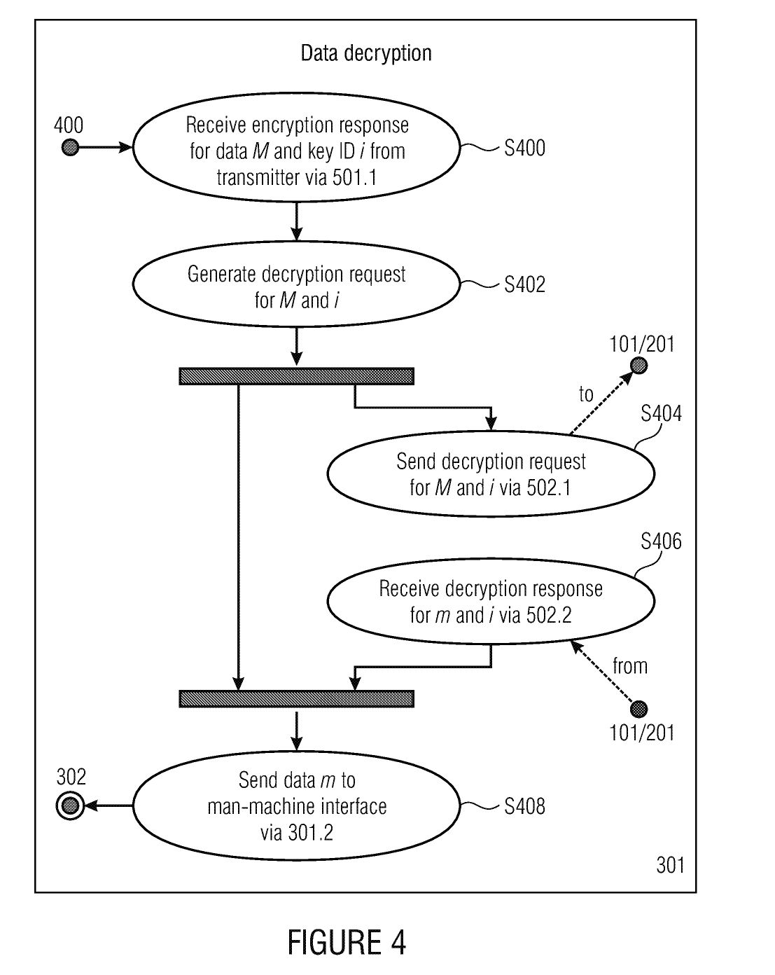

By means of FIG. 4, the steps performed in the integration module 301 are explained in connection with data decryption for displaying the decrypted data on the user interface 302 of the terminal device 300. In step S400, the integration module 301 receives, from a transmitter in the external environment 400, for example via a message 501.1, encrypted data M and the key ID i for the key kᵢ to be used for decrypting the encrypted data. In step S402, the integration module 301 generates a decryption request containing the encrypted data M and the key ID i. The decryption request thus generated is output, in step S404, by the integration module via its interface 301.4, for example in connection with a message 502.1, in the direction of the crypto module. Once decryption has been effected, the integration module 301 receives, in step S406, a decryption response which in addition to the decrypted data m also comprises the key ID i of the key kᵢ used for the encryption. The decryption response is received, for example, via the message 502.2, at the integration module 301, which in step S408 sends the decrypted data m contained in the decryption response to the user interface 302 while using a message 301.2.

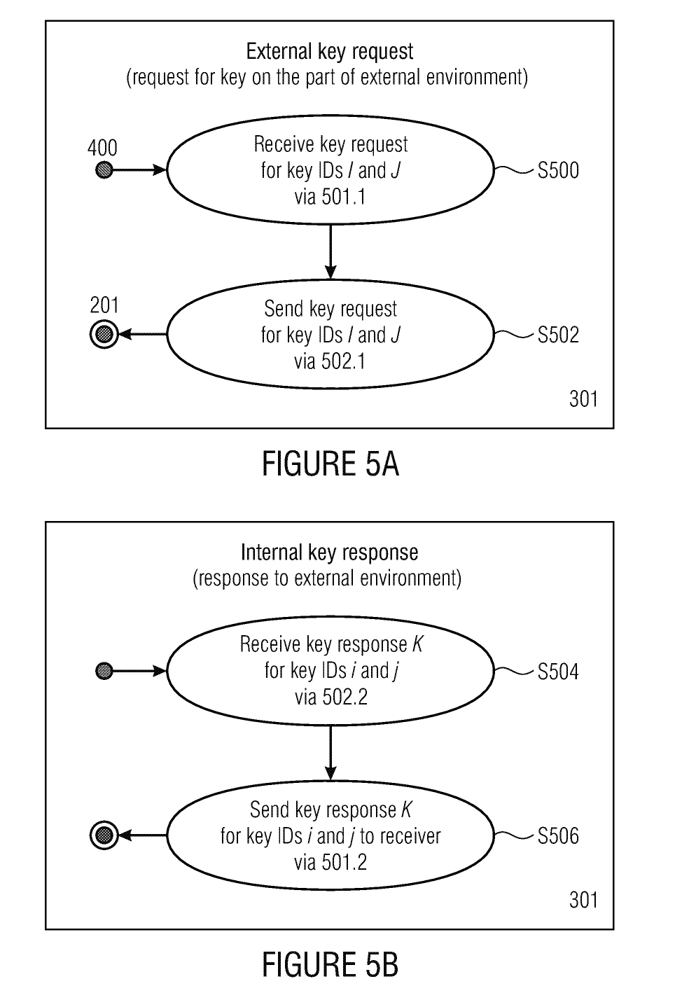

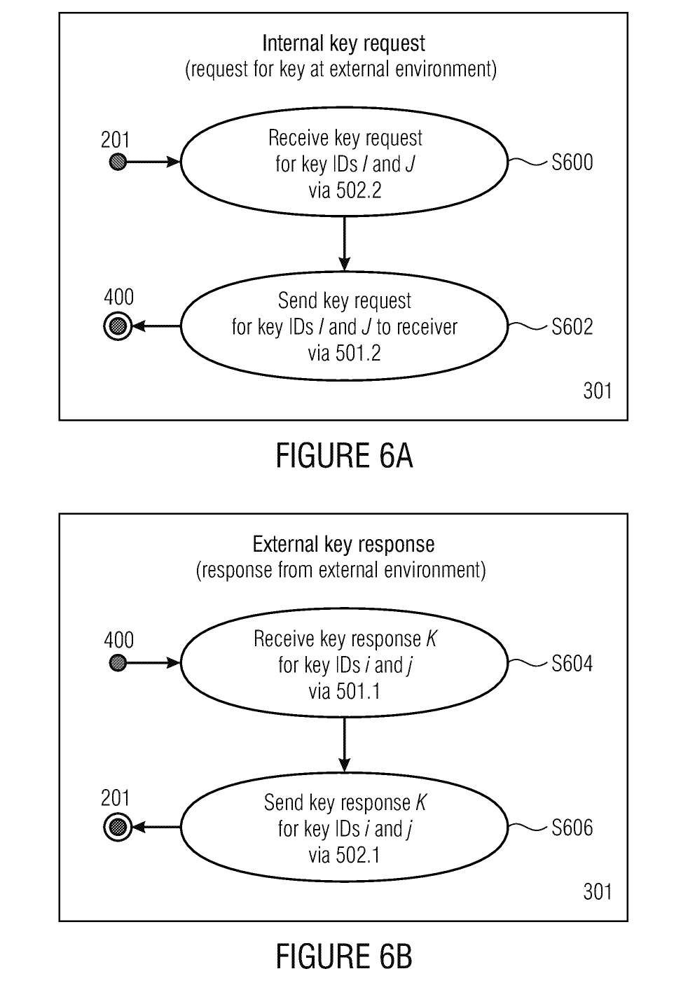

In addition to the functionality, described by means of FIGS. 3 and 4, of the integration module 301 in data encryption and in data decryption, the integration module 301 is active also in key requests, which will be explained in more detail below with reference to FIGS. 5 and 6. FIG. 5 describes flowcharts regarding the key request directed to the system, e.g. on the part of a transmitter in the external environment 400 (FIG. 5(a)), as well as regarding the system's response to the transmitter (see FIG. 5(b)). FIG. 5(a) depicts the situation where a transmitter in the external environment 400 directs a key request to the system in accordance with FIG. 2, which key request is received from the transmitter by the integration module 301, for example via the message 501.1, in step S500. The key request contains parameters I and J, each of which contains a specific number/amount of possible key IDs for the keys kᵢ and kⱼ. The key request received by the integration module 301 is forwarded from the integration module 301 in the direction of the communication module 201 in step S502. The integration module 301 merely serves to forward the request and is not involved in any further processing of the request. In response to the key request forwarded to the system, the integration module 301 receives, in step S504 (see FIG. 5(b)), a key response which, for one thing, contains the encrypted key K, which was generated on the basis of keys kᵢ and kⱼ (identified via the key IDs i and j, which are also contained in the response). The key response is received at the integration module 301, e.g. via the message 502.2 depicted in FIG. 2. The response thus received which contains the encrypted key K and the key IDs i and j is forwarded, in step S506, by the integration module 301 to the receiver in the external environment 400, e.g. via the message 502.2.

By means of FIG. 6, the functionality of the integration module 301 in connection with the request for a key, made on the part of the system (e.g. the crypto module 101) at a receiver in the external environment, will be explained in more detail. As is depicted in FIG. 6(a), the integration module 301 receives, in step S600, a key request which similarly to the key request in step S500 contains the amount of key IDs I and J. For example, the key request is received in step S600 from the communication module 201 via the message 502.2. The key request received is forwarded in step S602 to the receiver in the external environment 400 by the integration module 301, for example via the message 501.2. The receiver in the external environment 400 then generates the key which, after having been generated, is returned in an encrypted form K to the system shown in FIG. 2, which is illustrated by means of FIG. 6(b). FIG. 6(b) shows the situation where the integration module 301 receives, in step S604, a key response from the receiver in the external environment 400, which key response for one thing contains the encrypted key K and the identifications (key IDs i and j) of the keys kᵢ and kⱼ. For example, the key response is received at the device 300 or at the integration module 301 via the message 501.1. The key response thus received is forwarded to the system in step S604, for example to the communication module 201 via the message 502.1.

With regard to the integration module it shall be pointed out that according to embodiments, same may be provided unless the terminal device 300 exhibits the functionality that may be used for direct communication with the communication module 201 or for direct communication with the crypto module 101. In addition it shall be pointed out that the communication, described above by means of FIGS. 4 to 6, with the communication module 201 is provided when the latter is connected between the terminal device 300 and the crypto module 101. In embodiments wherein direct communication between the terminal device 300 or the integration module 301 and the crypto module 101 is possible, the communication module 201 may be dispensed with. In other words, the functionality described by means of FIGS. 4 to 6 may be provided either by the integration module 301 or, if the terminal device 300 is configured accordingly, by the terminal device itself, and the communication with the crypto module 101 may be effected either directly with the crypto module 101 or indirectly via the communication module 201.

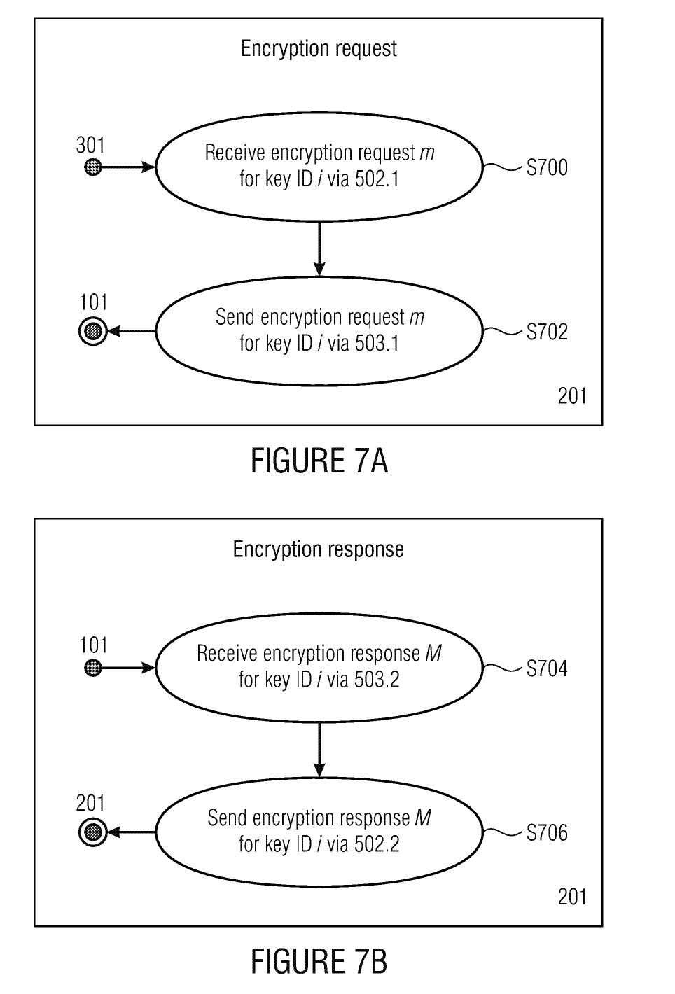

The functionality of the communication module 201, which according to embodiments of the invention is connected between the integration module 301 and the crypto module 101, shall be explained in more detail below with reference to FIGS. 7 to 15. The functionality described by means of the figures is provided, e.g., by the communication module processor 201.1 shown in FIG. 2.

By means of FIG. 7, the functionality of the communication module 201 in encrypting data shall initially be illustrated. FIG. 7(a) shows the functionality of the communication module 201 in connection with processing an encryption request received from the integration module 301 in step S700, the encryption request containing, as was already explained above, the data m to be encrypted as well as a key ID i via which a key kᵢ, which is to be used for encrypting the data m, is identified. The encryption request may be obtained, in step S700, from the integration module 301, for example via the message 502.1 (see FIG. 2). The encryption message thus obtained is sent, in step S702, to the crypto module 101 by the communication module 201 without any further processing. Once encryption has been effected, the encryption response is received, as is shown in FIG. 7(b), by the communication module 201 from the crypto module 101 in step S704, reception being effected, e.g., via the message 503.2 in FIG. 2. As was already explained above, the encryption message contains the encrypted data M as well as the key ID i. The encryption response received is sent to the integration module 301 by the communication module 201, for example via the message 502.2, in step S706.

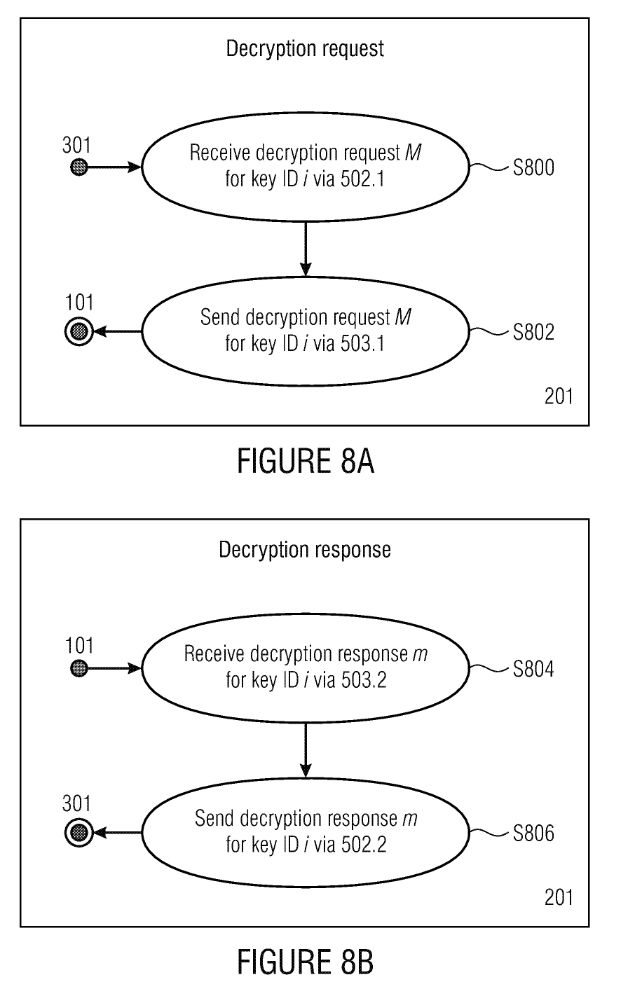

By means of FIG. 8, the functionality of the communication module 201 is explained in more detail in connection with the decryption of data. As can be seen by means of FIG. 8(a), the communication module 201 receives, in step S800, a decryption request from the integration module 301, for example via the message 502.1. In addition to the encrypted data M, the decryption message also contains the key ID i indicating the key kᵢ that is to be used for decrypting the encrypted data M. The decryption request received by the integration module 201 in step S800 is sent to the crypto module 101 via the message 503.1 in step S802. Following decryption, the communication module receives, as is shown in FIG. 8(b), a decryption response from the crypto module 301, for example via the message 503.2, in step S804. The decryption response contains the decrypted data m as well as the key ID i. The decryption response thus obtained is sent to the integration module 301 by the communication module 201 in step S806.

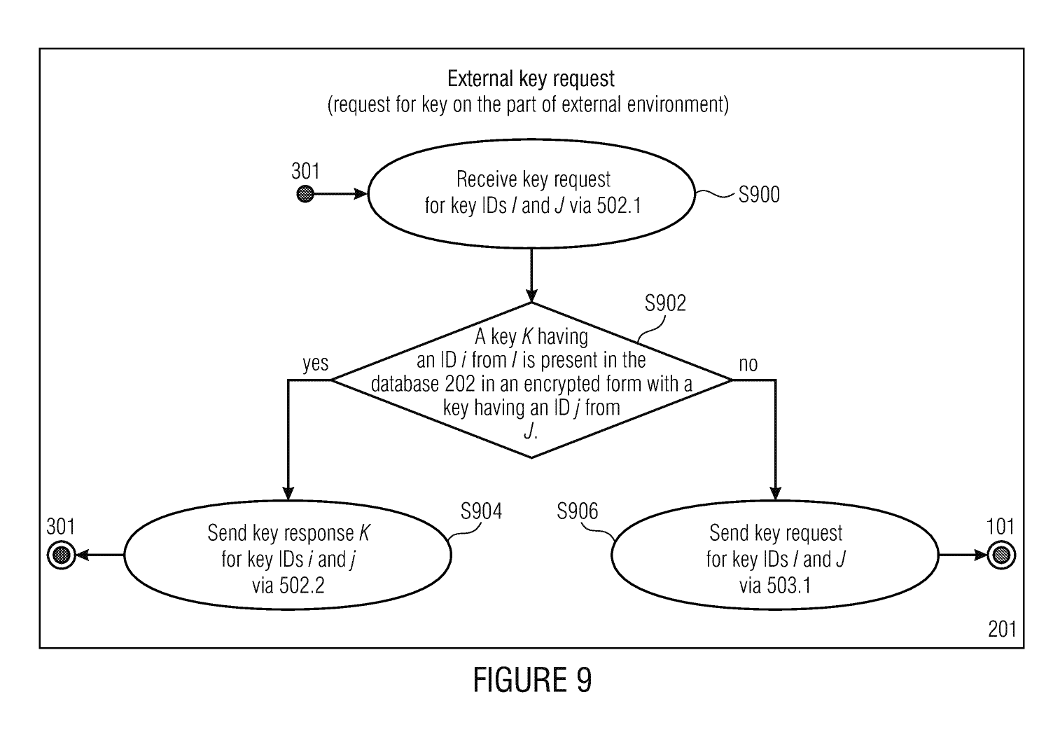

In accordance with further embodiments, the communication module is provided for processing key requests, as will now be explained by FIGS. 9 to 13.

FIG. 9 shows an embodiment wherein the communication module 201 is active in connection with a request for a key by the external environment 400. In step S900, the communication module 201 receives from the integration module 301 a key request containing an amount of key IDs I and J (see FIG. 5(a)), e.g. via the message 502.1. In step S902, the communication module 201 verifies whether or not an encrypted key K, which has a key ID i associated with it which is part of the amount of key IDs I, is present in the memory 202 in an encrypted form, the encrypted key K having been encrypted with a key with a key ID j from the amount of key IDs J. It shall be noted at this point that the key for encrypting the key K, the key kⱼ, need not be stored in the database 202 of the communication module; rather, it is one of the above-mentioned keys which according to embodiments may be stored exclusively in the crypto module, more specifically in the memory 102 thereof. If it is found in step S902 that such a key K is present in the database 202 of the communication module 201, a key response is generated, in step S904, which contains the key K (in an encrypted form) and the key IDs i, j. The key response is output to the integration module 301 via the message 502.2 (see FIG. 5(b)). If it is found in step S902 that no encrypted key K corresponding to the key request is present in the database 202 of the communication module 201, the key request received in step S900 is forwarded to the crypto module 101 by the communication module 201, for example via the message 503.1, in step S906; said crypto module 101 will then effect generation of the key, as will be described later on.

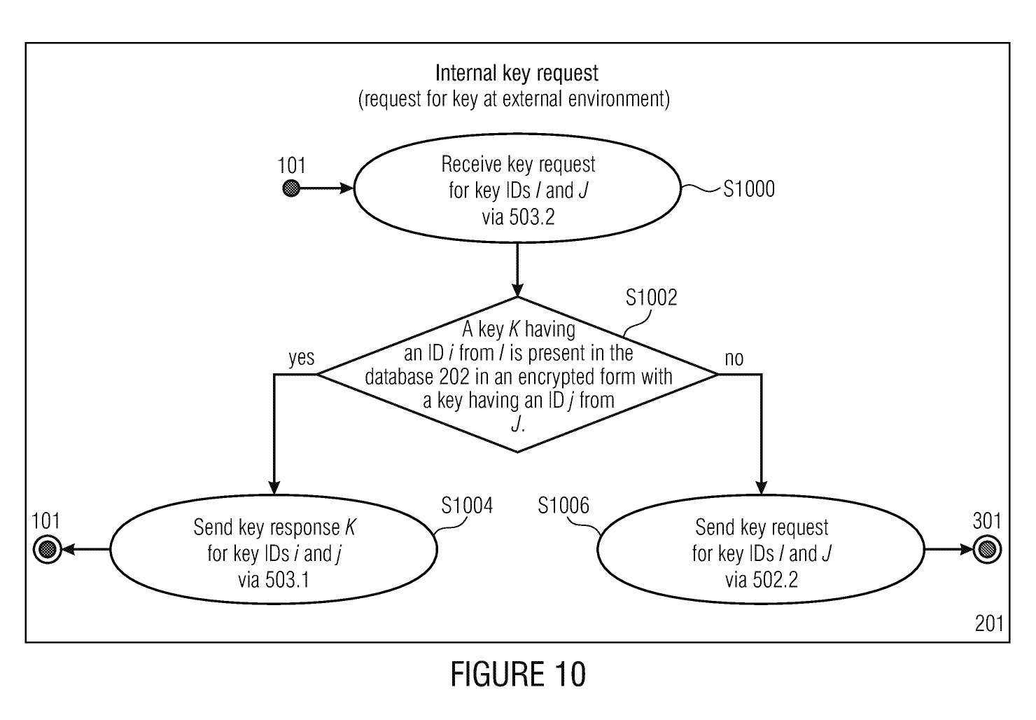

By means of FIG. 10, an example of the functionality of the communication module 201 in connection with a request for a key made by the system shown in FIG. 2 and directed to the external environment 400 will be explained in more detail. In step S1000, the communication module 201 receives a key request from the crypto module 101, for example via the message 503.2. Similarly to FIG. 9, also in FIG. 10, the key request contains an amount I, J of key IDs for the key. Similarly to step S902, step S1002 comprises verifying whether or not an encrypted key K which corresponds to the key request is present in the database 202 of the communication module 201. If such a key is present in the database 202, step S1004 comprises generating a key response which for one thing contains the encrypted key K and for another thing contains the associated key IDs i and j, similarly to step S904. The key response is sent to the crypto module 101 via the message 503.1 in step S1004. If the database 202 comprises no key, step S1006 comprises forwarding the key request received in step S1000 to the integration module 301, for example via the message 502.2 (see FIG. 6(a)), and from there, as was described above, to the external environment 400 which, in case a corresponding key is present there, will return the desired key to the system in FIG. 2 in an encrypted form (see FIG. 6(b)).

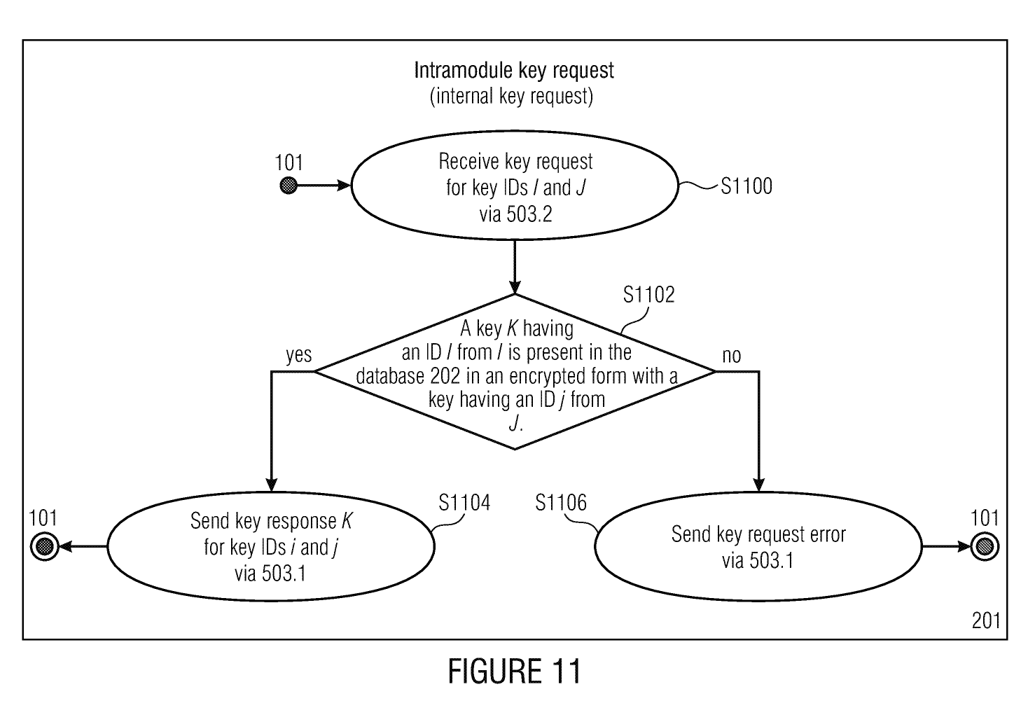

Instead of the request, described above by means of FIG. 10, for a key from the external environment, provision may also be made, according to embodiments, for the crypto module to perform an internal key determination (see the description later on) in accordance with which no request is directed to the external environment, but a request is directed only to the communication module. FIG. 11 shows a flowchart of a so-called intramodule key request, namely a request on the part of the crypto module 101 directed to the communication module 202 for a specific key. As is shown in FIG. 11, the crypto module 201 receives a key request from the crypto module 101, for example via the message 503.2, in step S1100. Similarly to the key requests contained in steps S900 and S1000, said key request contains the amount of key IDs I and J. Step S1102 comprises verifying whether or not an encrypted key K is present in the database 202 of the communication module 201, said verification being performed in accordance with what was already described above in steps S902 and S1002 by means of FIGS. 9 and 10. If it is found that an encrypted key K is present in the database 202 of the communication module 201, step S1104 comprises generating a key response containing the key K and the key IDs i and j and returning same to the crypto module 101 via the message 503.1. However, if it is found in step S1102 that no encrypted key K is present in the database 202, step S1106 comprises outputting a key request error to the crypto module 101, for example via the message 503.1, which crypto module 101 will subsequently generate a new key in response to such an error notification, as will be described in more detail below.

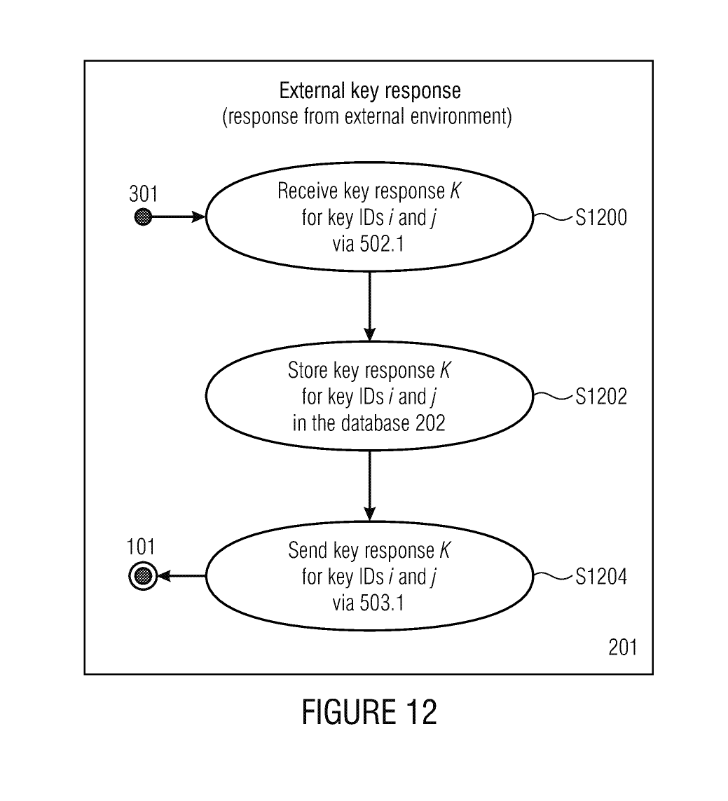

FIG. 12 shows the functionality of the communication module 201 in the event that a response is forwarded from the external system 400 following a request for a key made by the crypto module 101. In step S1200, the communication module 201 receives the key response from the integration module 301 via the message 502.1 (see FIG. 6(b)), the key response containing the encrypted key K as well as the key IDs i and j, which were received from the external system 400. In step S1202, the communication module 201 stores the received key response in the database 202, and in step S1204, the received key response is further forwarded to the crypto module 101 via the message 503.1.

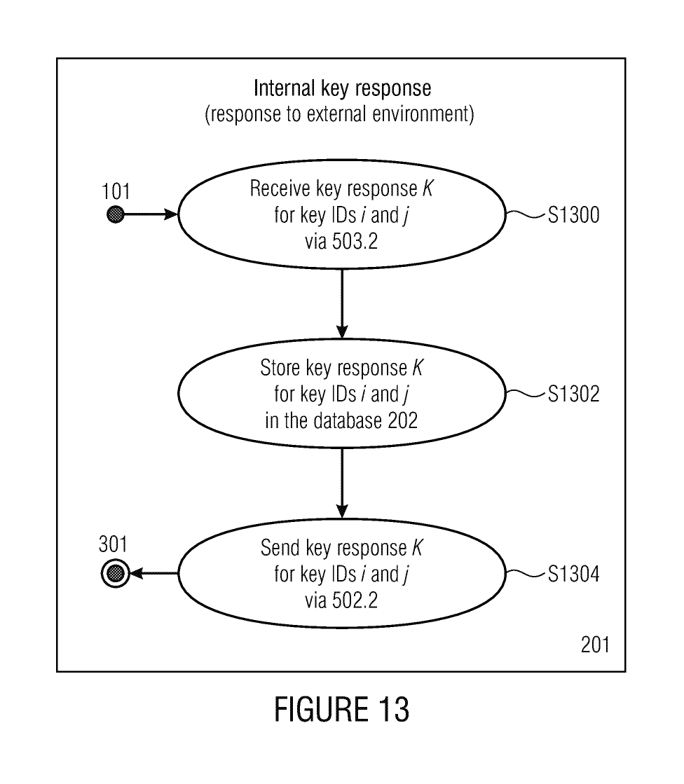

FIG. 13 shows the operational sequences within the communication module 201 for a situation wherein a response to a request, stemming from the external environment 400, for a key is provided by the crypto module 101. In step S1300, the communication module 201 receives the key response from the crypto module 101 via the message 503.2, said key response containing, similarly to the response received in step S1200, the encrypted key K as well as the key IDs i and j. In step S1302, the received key response is stored in the database 202 of the communication module 201, and in step S1304, the key response is forwarded to the integration module 301 for outputting same to the external environment 400 (see FIG. 6 (b)).

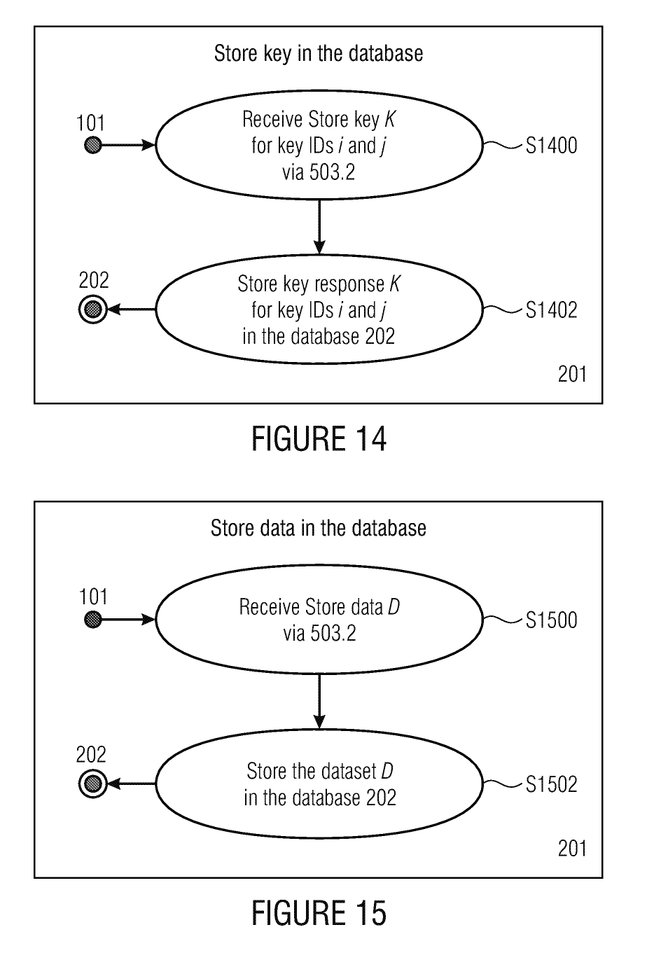

In addition to the modes of operation described by means of FIGS. 9 to 13, the communication module 201 may comprise further functionalities, in particular further functionalities so as to store, in response to instructions, data in the database 202 of the communication module 201, namely an encrypted key, as is described by means of FIG. 14, or data, as is described by means of FIG. 15. More specifically, FIG. 14 describes the functionality wherein the communication module 201 receives the message “Store key” from the crypto module 101 via the message 503.2 in step S1400, which message contains the encrypted key K as well as the key IDs i and j. The information thus received is stored in the database 202 of the communication module 201 in step S1402. Similarly, the communication module 201 operates in the event that data is stored in its database 202. FIG. 15 depicts the situation where the crypto module 101 sends a Store data message to the communication module 201 via the message 503.2, which message is received there in step S1500. The message thus received contains the data D, and in step S1502, the data set D contained in the message 502.2 is stored in the database 202.

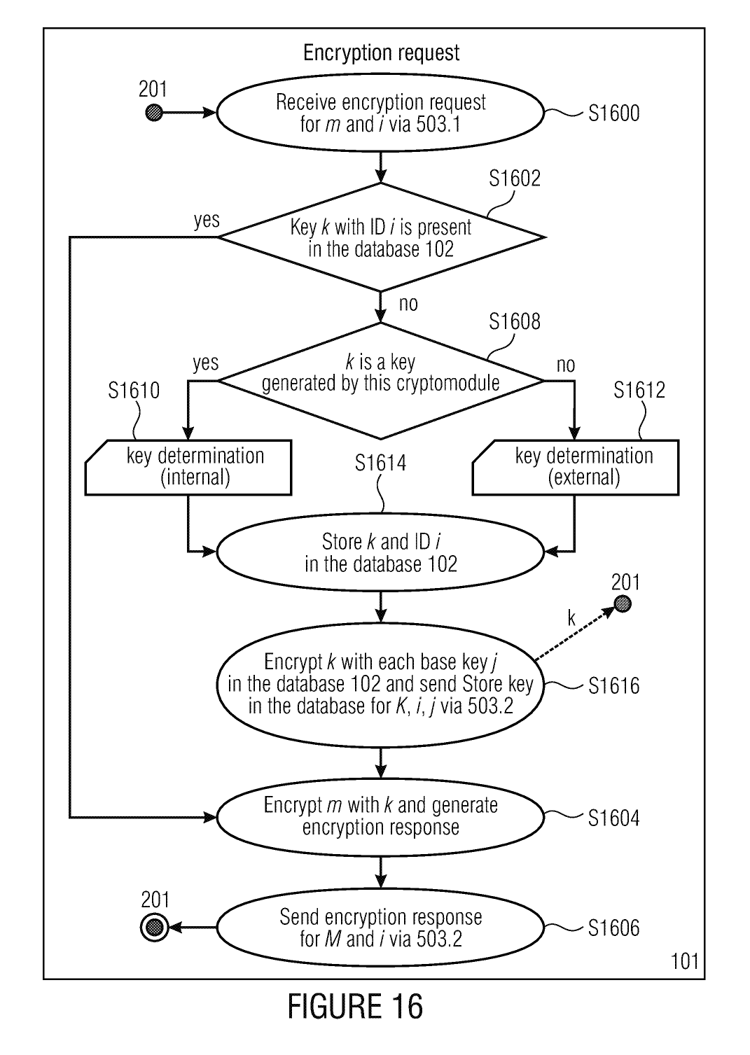

The functionality of the inventive crypto module will be explained below in more detail with reference to FIGS. 16 to 21. The functionality described by means of the figures is provided, e.g., by the crypto processor 101.1 shown in FIG. 2. At this point it shall be noted that the following description of the functionality of the crypto module will be provided in connection with the system shown in FIG. 2, i.e. a system which, in addition to the crypto module, also comprises the optional integration module and the optional communication module. As was already mentioned above, according to other embodiments a communication of the crypto module may also be effected directly with the terminal device 300 or directly with a terminal device 300, which comprises the integration module 301, without interposition of the communication module 201.

The functionality of the crypto module 101 in connection with the processing of an encryption request will be explained in more detail with reference to FIG. 16. In step S1600, the crypto module 101 receives from the communication module 201 the encryption request, which contains the data m to be encrypted as well as the key ID i indicating the key kᵢ to be used for encryption. The encryption request is received in step S1600 via the message 503.1, for example via the interface 101.4 of the crypto module 101. Step S1602 comprises determining whether or not the database 102 of the crypto module 101 contains the key kᵢ associated with the key ID i. If the database 102 contains the key kᵢ, encryption of the data m with the key kᵢ present in the database 102 will be performed in step S1604, and a corresponding encryption response will be generated. In step S1606, the encryption response generated in step S1604, which contains the now encrypted data M and the key ID i, is sent to the communication module 201, for example via the message 303.2 (see FIG. 7(a)).

If it is found, in step S1602, that the key i, i.e. “kᵢ”, is no longer contained in the database 102, step S1608 comprises determining, on the part of the crypto module 101, whether or not the key i, i.e. “kᵢ”, is to be generated in the crypto module 101. If it is found that the key is to be generated internally within the crypto module 101, step S1610 comprises performing internal key determination, which will be explained in more detail below. If it is found that the key is not to be generated within the crypto module, an external key determination is caused in step S1612, as will also be explained in more detail below. Both the internal and the external key determinations in step S1610 and in step S1612 result in a key kᵢ with an associated key ID i, both of which are stored in the database 102 of the crypto module 101 in step S1614. The key kᵢ stored in the database 102 is encrypted, in step S1616, with each base key (key with the identifications j from the amount J) that are stored in the database 102, and moreover, a storage key message is produced which is sent to the communication module via the message 503.2 so as to store the encrypted key K in the database 202 of the communication module 201 (see FIG. 14). The notification “Store key” contains the encrypted key K as well as the key IDs i, j, which indicate the unencrypted key kᵢ as well as the key kⱼ that was used for encrypting the key kᵢ. The key kᵢ generated in steps S1610 to S1616 is used, in step S1604, for encrypting the unencrypted data m and for generating the encryption response.

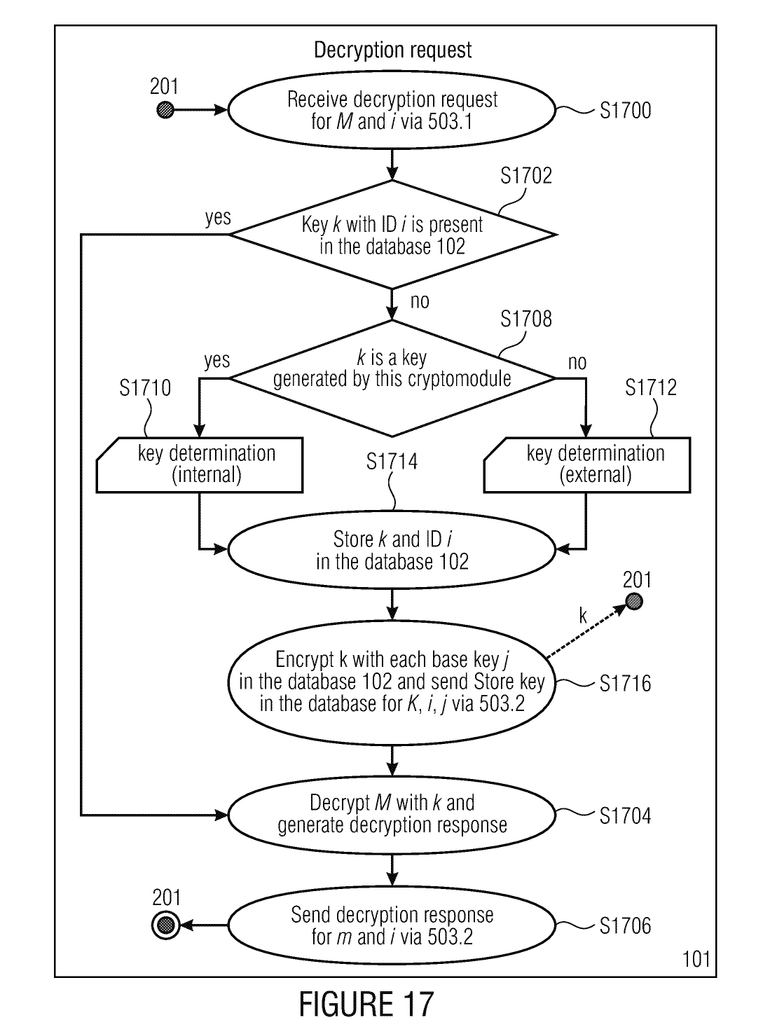

The functionality of the crypto module 101 will be explained in more detail below in connection with the processing of a decryption request with reference to FIG. 17. In step S1700, the crypto module 101 receives the decryption request from the communication module 201, for example via the message 503.1 in FIG. 2 (see FIG. 7(b)). The decryption request contains the encrypted data M as well as the key ID i, which indicates the key with which the data M has been encrypted. Step S1702 comprises determining whether or not the key kᵢ, which has the key ID i associated with it, is contained in the database 102 of the crypto module 101. If the key kᵢ is contained in the database 102, step S1704 comprises decrypting the encrypted data M while using the key kᵢ and generating a decryption response output in step S1706, via the message 503.2, to the communication module 201 for being forwarded to the integration module 101. The decryption message contains the decrypted data m as well as the key ID i. If it is found in step S1702 that the key kᵢ is not contained in the database 102 of the crypto module, the key is determined either internally or externally, is stored and is forwarded to the communication module 201 in an encrypted form, as is set forth by means of steps S1708 to S1716, which correspond to steps 1608 to 1616 of FIG. 16 and are not described once again.

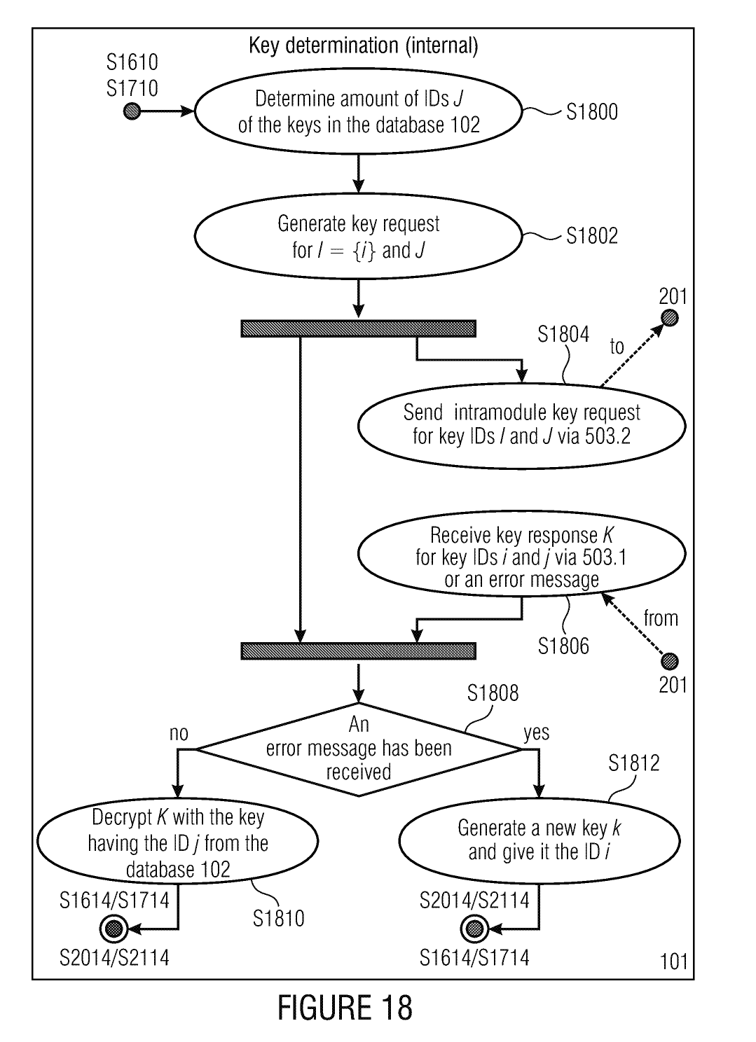

An example of the operational sequences performed within the crypto module 101 for internal key determination (see steps S1610 in FIG. 16 and S1710 in FIG. 17) will be described below by means of FIG. 18. On the basis of the above-mentioned steps S1610 and S1710, respectively, a first step S1800 comprises determining the amount of the key IDs J of all of the keys within the database 102 of the crypto module 101 on the part of the crypto module 101, for example, of the crypto processor 101.1. In step S1802, the crypto module 101 generates a key request for the key IDs I, J, which is sent to the communication module 201 in step S1804, for example via the message 503.2, the communication module 201 generating a response, in accordance with the functionality described by means of FIG. 11, to the request received by the crypto module in step S1806. More specifically, step S1806 comprises receiving, at the crypto module 101, either a key response containing the encrypted key K and generated by the step S1104 in FIG. 11, or the error message generated by the step S1106 in FIG. 11. Step S1810 comprises determining whether or not the received message was an error message. If the received message is not an error message, step S1812 comprises decrypting the received key K by using a key determined by the key ID j from the received key response, and the key kᵢ thus decrypted is used in step S1614 and S1714, respectively (in FIGS. 16 and 17, respectively). If an error message was received in step S1806, the method will proceed from step S1808 to step S1812, where the crypto module generates a new key kᵢ, for example by means of the crypto processor, and associates the key ID i with same. The key thus generated is then also provided to steps S1614 and/or S1714.

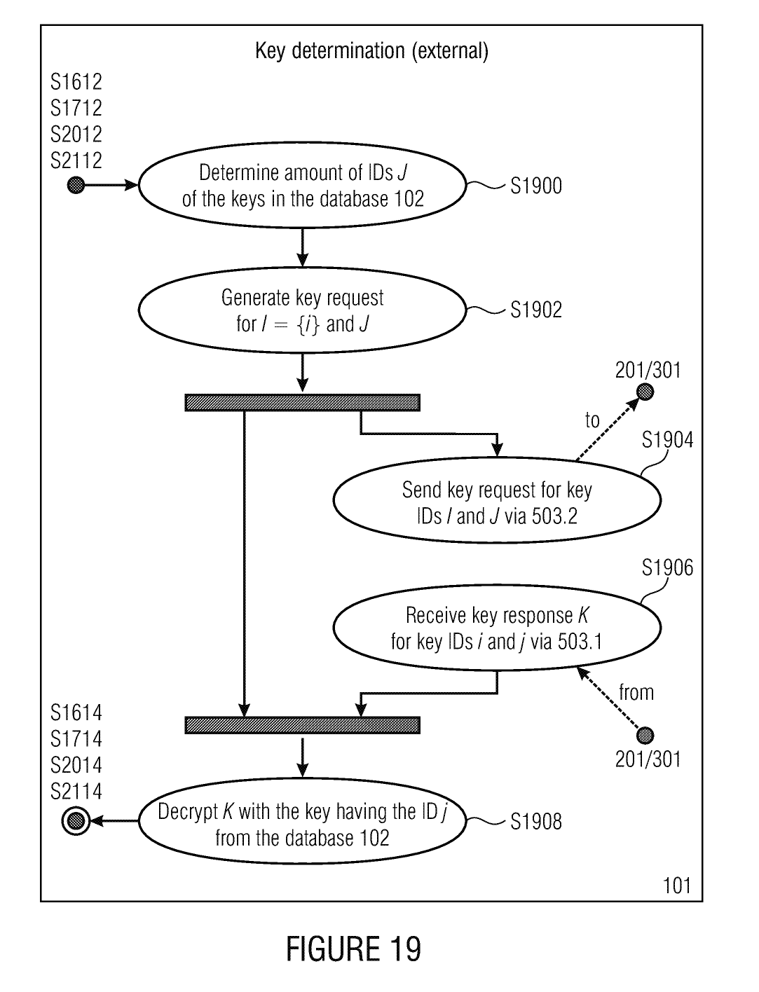

FIG. 19 describes the functionality within the crypto module 101 in connection with external key determination. In the event of external key determination, the crypto module 101 determines, in step S1900, similarly to step S1800, the amount of the key IDs J of the keys, namely of all of the keys stored in the database 102 of the crypto module 101. Similarly to step S1802, step S1902 comprises generating a key request which is output to the communication module in step S1904, for example via the message 103.2, and is processed there, for example in accordance with the functionality described by means of FIG. 10. In step S1906, the crypto module 101 receives, from the communication module 201, the encrypted key K that was either contained in the database 202 of the communication module 201 or was obtained from the external environment; in addition to the key K, key IDs i and j are also received via the message 103.1. On the basis of the data received, step S1908 comprises decrypting the key K with the key that is associated with the key ID j from the database 102, and the decrypted key kᵢ is provided to the step S1614 and/or S1714.

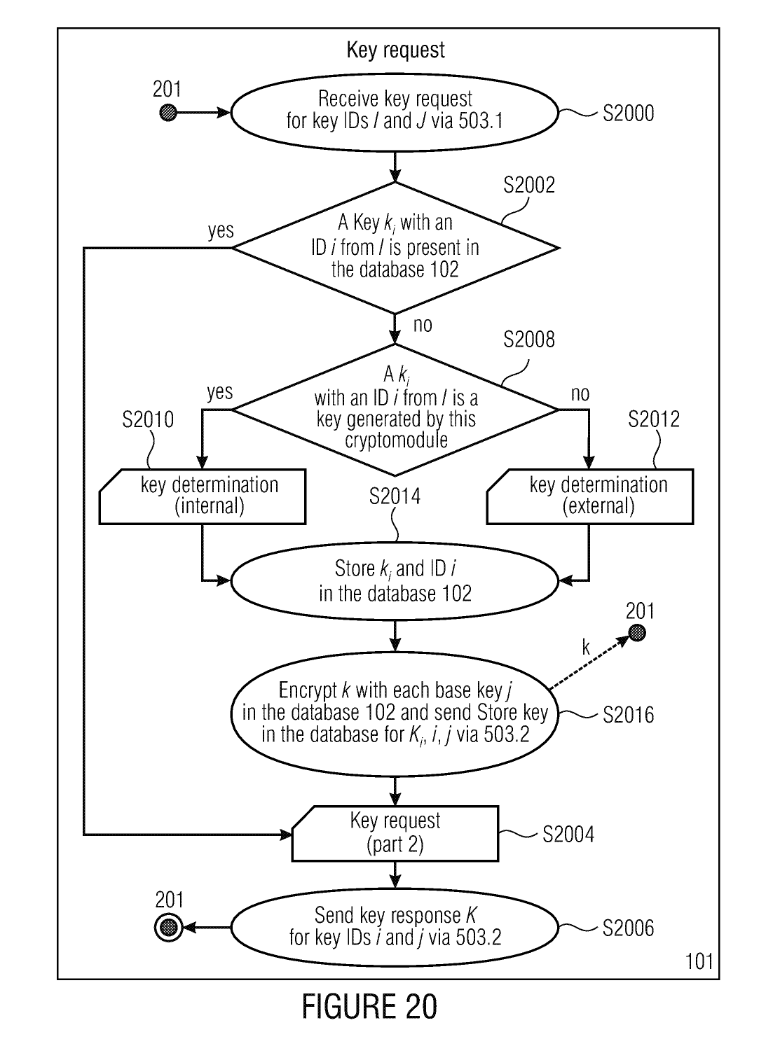

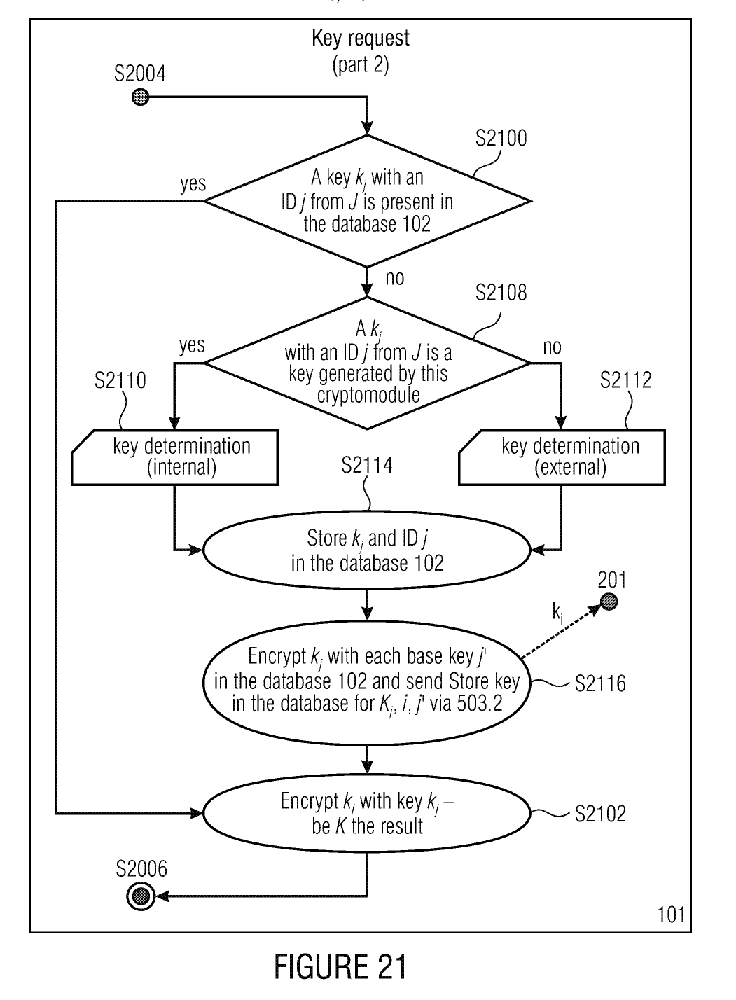

The functionality of the crypto module will be explained in more detail below, with reference to FIGS. 20 and 21, in connection with the processing of a key request and/or providing of an encrypted key to the communication module 201. In step S2000, a key request is received by the crypto module 101 from the communication module 201 (see the functionality, described by means of FIG. 6(a) and FIG. 9, of the integration module and/or of the communication module). The key request contains a request for a key defined by the amounts of key IDs I and J, it being possible to receive the request at the crypto module via the message 103.1. Step S2002 comprises determining whether or not a key kᵢ, associated with the key ID i from the amount I, is contained in the database 202 of the crypto module 101. If this is so, the method proceeds to step S2004, where a second part of processing the key request is performed, which will be explained below with reference to FIG. 21. If it is found in step S2002 that the key kᵢ does not exist in the database 102, the following steps comprise internally or externally determining a key kᵢ, storing same in the database 102 and encrypting same, the encrypted key then also being forwarded to the communication module 201 for being stored in the database thereof. The pertinent steps S2008 to S2016 correspond to the steps S1608 to S1616 and S1708 to S1716 that were described in FIGS. 16 and 17, respectively, and the methods for internal and/or external key determination in the steps S2010 and S2012 correspond to the steps described by means of FIGS. 18 and 19, so that a repeated description thereof is dispensed with. Step S2004 then comprises using either the key kᵢ contained in the database or the newly generated one kᵢ that is provided by step S2016.

The functionality of the crypto module will be explained, by means of FIG. 21, in connection with the second part of the processing of the key request. The second part of the key request relates to ascertaining whether or not a key for encrypting the first key is available, namely a key kⱼ identified by the key ID j (from the amount of IDs J). Step S2100 comprises initially determining whether or not a key kⱼ is contained in the database 102 of the crypto module 101. If this is so, the method proceeds to step S2102, during which the key kᵢ known from step S2004 is encrypted with the key kⱼ, which results in the encrypted key K, which is then returned to the step S2004. However, if it is found in step 2100 that the key kⱼ does not exist in the database, a new key kⱼ is determined either internally or externally and encrypted by steps S2108 to S2116, the encrypted key Kⱼ being output to the communication module 201 for being stored in the database 202 thereof. The steps S2108 to S2116 correspond to the steps S1608 to S1616 and S1708 to S1716, respectively, which are described by means of FIGS. 16 and 17, except for the fact that instead of the key kᵢ, the key determined now is the key kⱼ; the functionality is the same, and therefore, please refer to the above-described approach in terms of FIGS. 16, 17, 18, and 19 as far as the functionality of steps S2108 to S2116 is concerned.

The above-described embodiments are a possible implementation of rules in connection with a central key management system ensuring that outside the crypto module realized in hardware, keys occur in an encrypted form only, and that corresponding encryption of the key kᵢ is performed only with such keys kⱼ from which the authorization may be derived that access to the data is allowed. Said rules are taken into account in particular in the above-described sections regarding the mode of operation of the crypto module, wherein the function “Store key” is fetched for storing the key in the communication module. Likewise, these rules as were explained above are also taken into account when implementing the key request on the part of the crypto module, and a key request violating said rules will, according to the embodiments of the invention, not be responded to with the associated key response.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described in connection with or as a method step also represent a description of a corresponding block or detail or feature of a corresponding device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable. Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer. The program code may also be stored on a machine-readable carrier, for example.

Other embodiments include the computer program for performing any of the methods described herein, said computer program being stored on a machine-readable carrier.

In other words, an embodiment of the inventive method thus is a computer program which has a program code for performing any of the methods described herein, when the computer program runs on a computer. A further embodiment of the inventive methods thus is a data carrier (or a digital storage medium or a computer-readable medium) on which the computer program for performing any of the methods described herein is recorded.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A hardware crypto module for encrypting or decrypting data from a device that is arranged to be remote and separate from the crypto module in terms of hardware, the crypto module comprising:
an interface for communicating with the remotely arranged device,
a memory,
a crypto processor configured
to encrypt or decrypt, while using the first key, data received via the interface,
to encrypt the first key while using a second key stored in the memory, and
to output the first key via the interface exclusively in an encrypted form.

2. The crypto module as claimed in claim 1, wherein the crypto processor is configured, in response to receiving data to be encrypted and a first key ID of the first key via the interface,
to determine, on the basis of the received first key ID, whether or not the first key is comprised by the memory,
if the first key is comprised by the memory, to encrypt the data to be encrypted with the first key, and to output the encrypted data and the first key ID of the first key via the interface, and
if the first key is not comprised by the memory, to generate the first key.

3. The crypto module as claimed in claim 1, wherein the crypto processor is configured, in response to receiving data to be decrypted and a first key ID of the first key via the interface,
to determine, on the basis of the received first key ID, whether or not the first key is comprised by the memory,
if the first key is comprised by the memory, to decrypt the data to be decrypted with the first key, and to output the decrypted data and the first key ID of the first key via the interface, and
if the first key is not comprised by the memory, to generate the first key.

4. The crypto module as claimed in claim 1, wherein the crypto processor is configured, in response to receiving a request for a first key,
to determine, on the basis of a first key ID of the first key and on the basis of a second key ID of the second key, which are comprised by the request, whether or not the first key and the second key are comprised by the memory,
if both keys are comprised by the memory, to encrypt the first key with the second key and to output the encrypted first key, the first key ID, and the second key ID via the interface, and
if one or both keys are not comprised by the memory, to generate the first and/or second key(s), to encrypt the first key with the second key, and to output the encrypted first key, the first key ID, and the second key ID via the interface.

5. The crypto module as claimed in claim 2, wherein the crypto processor for generating the first key is configured
to generate, on the basis of the first key ID and the second key ID, a request regarding the first key, and to output same via the interface,
to decrypt the encrypted first key on the basis of the second key indicated by the second key ID, in response to receiving the encrypted first key, the first key ID associated with the first key, and the second key ID associated with the second key, and
to generate, in response to receiving an error message, a new first key and to associate the first key ID with said newly generated first key.

6. The crypto module as claimed in claim 2, wherein the crypto processor is configured to store, after having generated the first key, the first key in the memory, to encrypt the first key with the second key, and to output the encrypted first key via the interface.

7. The crypto module as claimed in claim 6, wherein the memory stores a plurality of second keys, and wherein the crypto processor is configured to generate several versions of the encrypted first key by encrypting the first key with several ones of the second keys from the memory, and to output the versions of the encrypted first key via the interface.

8. The crypto module as claimed in claim 7, wherein the crypto processor is configured to output, together with the versions of the encrypted first key, the first key ID of the first key and the second key ID of the version of the encrypted first key, the second key ID indicating those keys among the second keys with which the corresponding version of the encrypted first key was generated.

9. A system for communicating with an external environment, comprising:
a device comprising an interface with the external environment, and
a hardware crypto module as claimed in claim 1, which is separate from the device in terms of hardware and is configured to communicate with the device via its interface.

10. The system as claimed in claim 9, wherein the device is configured to send data that is to be sent to the external environment to the crypto module, to receive the encrypted data from the crypto module, and to send the encrypted data to the external environment via its interface.

11. The system as claimed in claim 10, wherein the device is configured
to generate a encryption request, which comprises the data to be encrypted and the first key ID for the first key, and to send it to the crypto module, and
to receive a response from the crypto module and send it to an external environment, the response comprising the encrypted data and the key ID of the first key.

12. The system as claimed in claim 9, wherein the device is configured to send encrypted data that have been received from the external environment to the crypto module to be decrypted, to receive the decrypted data from the crypto module, and to provide same via the device.

13. The system as claimed in claim 12, wherein the device is configured to generate a decryption request, which comprises the encrypted data and the first key ID for the first key, and to send it to the crypto module, and
to receive, from the crypto module, a response which comprises the decrypted data and the key ID of the first key, and to provide the decrypted data comprised by the response received.

14. The system as claimed in claim 9, wherein the device is configured to direct a key request from the external environment to the crypto module, to direct a key request of the crypto module to the external environment, and to forward the respective response to the external environment or to the crypto module.

15. The system as claimed in claim 9, wherein the device comprises a communication module comprising:
an interface configured for communicating with the crypto module,
a memory, and
a communication processor effectively connected to the interface and the memory.

16. The system as claimed in claim 15, wherein the communication processor is configured to forward the encryption request and the decryption request to the crypto module via its interface and to receive the response from the crypto module.

17. The system as claimed in claim 15, wherein the communication processor is configured
to determine, in response to a key request comprising the first key ID of the first key and the second key ID of the second key, whether or not an encrypted version of the first key which was generated by encrypting the first key with the second key is comprised by the memory of the communication module,
if the memory comprises the encrypted first key, to output the encrypted first key, the first key ID, and the second key ID, and
if the memory does not comprise the encrypted first key,
to forward the key request to the crypto module if the key request stems from the external environment,
to forward the key request to the external environment if the key request stems from the crypto module and if external key determination is allowed, and
to send an error message to the crypto module if the key request stems from the crypto module and if external key determination is not allowed.

18. The system as claimed in claim 15, wherein the communication processor is configured to store the encrypted first key along with the first and second key IDs in the memory in response to receiving an encrypted version of the first key.

19. The system as claimed in claim 15, wherein the device further comprises an integration module comprising an interface configured for communicating with the communication module, a user interface, and a signal processor effectively connected to the interface and the user interface.

20. The system as claimed in claim 19, wherein the signal processor of the integration module is configured,
in response to receiving data to be encrypted from the user interface, to generate the encryption request, to forward the encryption request to the communication module, and to output the response from the communication module, and,
in response to receiving encrypted data, to generate the decryption request, to forward the decryption request to the communication module, and to output the response from the communication module via the user interface.

21. The system as claimed in claim 19, wherein the signal processor is configured to forward a key request and a response to the key request to the external environment and/or to the communication module.

22. The system as claimed in claim 9, wherein the communication module and/or the integration module are realized as a software module in the device or as a separate hardware module for the device.

23. The system as claimed in claim 9, wherein the device comprises a computer, a laptop, a notebook, a tablet computer, or a smartphone, and wherein the external environment comprises a public or internal network or a public or internal memory, computing center, or cloud.
